(19) United States
(12) Patent Application Publication
(10) Pub. No.: US 2013/0271511 A1
(43) Pub. Date: Oct. 17, 2013

(54) DISPLAY DEVICE AND COLOR-CORRECTION METHOD FOR DISPLAY DEVICE

(71) Applicants: Ryuuichi Fujimura, Tokyo (JP); Katsuyuki Matsui, Tokyo (JP)

(72) Inventors: Ryuuichi Fujimura, Tokyo (JP); Katsuyuki Matsui, Tokyo (JP)

(21) Appl. No.: 13/989,834

(22) PCT Filed: Nov. 30, 2010
(86) PCT No.: PCT/JP10/71392

§ 371 Date: Jun. 21, 2013

(51) Int. Cl. G09G 5/02

(52) U.S. Cl. CPC G09G 5/02
USPC 345/690

(57) ABSTRACT

A display device includes a backlight power detector for detecting electrical power driving a backlight; a luminance detector for detecting luminance of a display panel; a luminous efficiency chromaticity storage unit for storing the relationship between display chromaticity and a luminous efficiency calculated based on display luminance and backlight power; and a chromaticity correction device for calculating a luminous efficiency based on the detection result of the backlight power detector and the detection result of the display luminance detector, for reading the display chromaticity, corresponding to the calculated luminous efficiency, from the luminous efficiency chromaticity storage unit, and for correcting the display chromaticity of a video signal, thus matching the display chromaticity displayed on the display panel with the read display chromaticity.

### TECHNICAL FIELD

The present invention relates to a display device, which corrects chromaticity of an image displayed on a display panel, and a color-correction method for a display device.

### BACKGROUND ART

Display devices may undergo variations of display colors due to ambient environments. For this reason, it is necessary to carry out a purpose of suppressing variations of display colors by way of a generally-known technique in which a display device is equipped with a temperature sensor for detecting its temperature so as to correct a display color based on the detected value of the temperature sensor (hereinafter, referred to steady correction). In particular, it is necessary to implement periodic correction for display devices in industrial fields requiring strict color reproduction. Patent Literatures 1, 2 are well known as technologies for correcting chromaticity (i.e. viewers' coloration).

With the steady correction, however, it is impossible to precisely correct transient variations of chromaticity in a temperature increasing period due to self-heating in a power-on mode. FIG. 4 is a graph showing variations of chromaticity. As shown in this graph, a difference between the target chromaticity and the actual chromaticity displayed on a display panel just after a power-on mode is larger than the difference between them after a lapse of a certain time.

This is because a time delay may occur while heat is transmitted from a heating element, causing a light-source temperature and a display color variation, to air inside a device proximate to a position of a temperature sensor, thus causing a temperature gradient. This may depend on specific heat and heat conductivity of built-in members of a device. Generally speaking, it is possible to actually detect a temperature increase after five to ten minutes elapsed in a power-on mode.

This may cause a problem in which it is impossible to display true color due to a transient variation of chromaticity in a display color just after a power-on mode, and it is therefore impossible to start correction with a display device. Generally speaking, it is necessary to start correction after continuously applying power in a certain time (e.g. thirty minutes) to stabilize an internal temperature of a device and other parameters.

Upon using a temperature as a parameter, a long tracking delay of a sensor (e.g. five to ten minutes) may occur to prevent precise correction, while rapid tracking may reduce a temperature variation in a device, which may be susceptible to measurement noise such as wind; hence, it is very difficult to perform transient correction by directly detecting a temperature variation; this may be another cause of a problem.

### CITATION LIST

### Patent Literature

Patent Literature 1: Japanese Patent Application Publication No. 2007456157

Patent Literature 2: Japanese Patent No. 4496270

### SUMMARY OF INVENTION

### Technical Problem

It is necessary to solve a problem concerning a disability of precisely correcting a transient variation of chromaticity in a temperature increasing period due to self-heating just after a power-on mode.

### Solution to Problem

The present invention is characterized by comprising a display panel for displaying an input video signal; a backlight for illuminating the display panel; a backlight power detector for detecting electrical power driving the backlight; a luminance detector for detecting the luminance of the display panel; a luminous efficiency chromaticity storage unit for storing the relationship between a luminous efficiency, which is calculated based on display luminance and backlight power, and display chromaticity; and a chromaticity correction device for calculating a luminous efficiency based on the detection result of the backlight power detector and the detection result of the display luminance detector, for reading the display chromaticity, corresponding to the calculated luminance efficiency, from the luminous efficiency chromaticity storage unit, and for correcting the display chromaticity of the video signal, thus matching the display chromaticity displayed on the display panel with the read display chromaticity.

Additionally, the present invention is characterized by providing a color correction method for a display device comprising the steps of: detecting electrical power driving a backlight illuminating a display panel; detecting the luminance of the display panel; calculating a luminous efficiency based on the detection result of backlight power and the detection result of luminance; reading the display chromaticity, corresponding to the calculated luminous efficiency, from a luminous efficiency chromaticity storage unit for storing the relationship between the luminous efficiency, calculated based on the display luminance and the backlight power, and the display chromaticity; and correcting the display chromaticity of a video signal input to the display panel, thus matching the display chromaticity, displayed on the display panel, with the read display chromaticity.

### Advantageous Effects of Invention

The present invention is able to precisely correct chromaticity even when a transient variation of chromaticity occurs in a temperature increasing period due to self-heating just after a power-on mode.

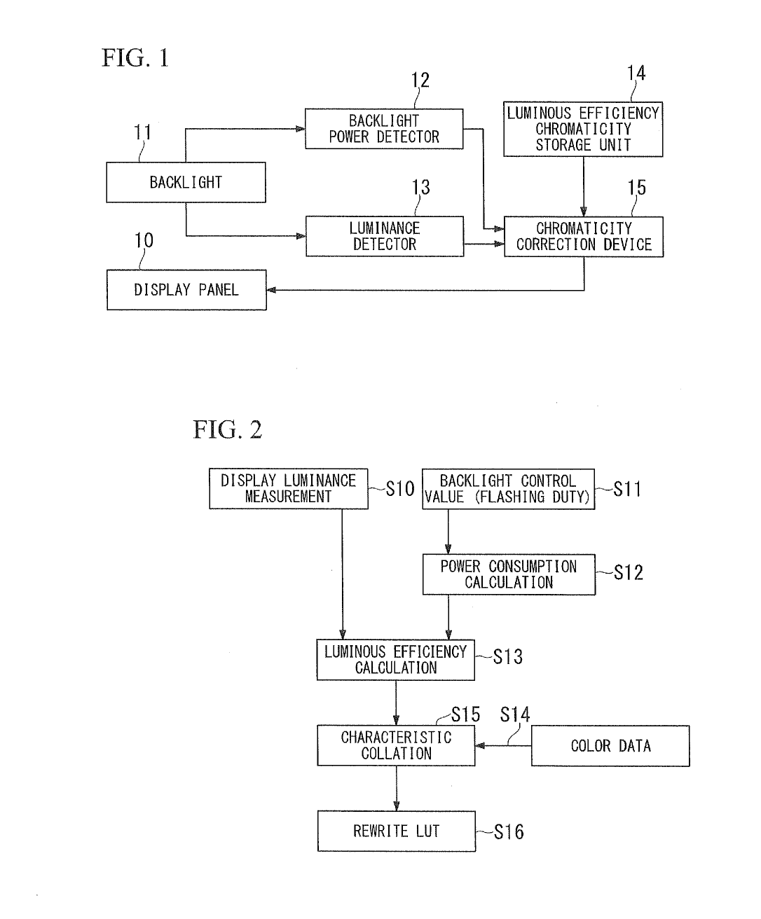

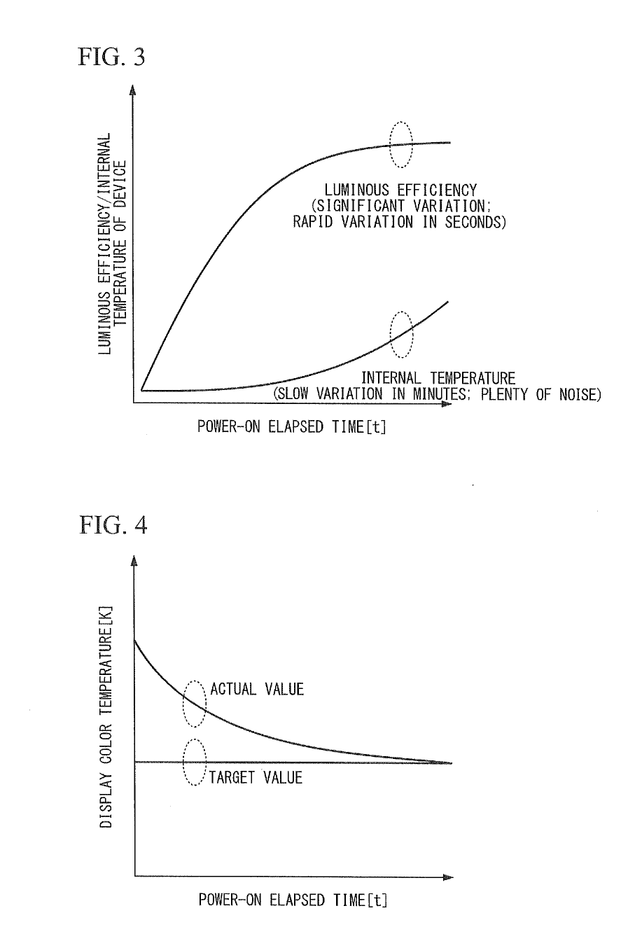

### BRIEF DESCRIPTION OF DRAWINGS

[FIG. 1] A block diagram showing the configuration of a display device according to one embodiment of this invention.

[FIG. 2] A flowchart illustrating the operation of the display device having the configuration of FIG. 1.

[FIG. 3] A graph showing the relationship between a luminous efficiency or an internal temperature of a device and an elapsed time after a power-on mode.

[FIG. 4] A graph showing variations of chromaticity.

### DESCRIPTION OF EMBODIMENT

Hereinafter, a display device according to one embodiment of the present invention will be described with reference to the drawings.

FIG. 1 is a block diagram showing the configuration of a display device according to one embodiment of this invention. A display panel 10 displays an image in response to a video signal input thereto. A backlight 11 irradiates light to illuminate the display panel 10. A backlight power detector 12 detects electrical power driving the backlight 11. It is possible to detect the drive power which is calculated based on a characteristic measured in advance by use of a control value of a light source (e.g. flashing duty, voltage, or current). Herein, the backlight power detector 12 may store a control value and drive power, related to the control value, in a memory device. Upon detecting a control value, it may read the drive power, corresponding to the control value, from the memory device.

A control value of a light source (e.g. flashing duty, voltage, or current) may represent the relative drive power. For the sake of simplicity, it is possible to deal a control value of a light source with drive power.

The luminance detector 13 detects the luminance of the display panel 10. The luminous efficiency chromaticity storage unit 14 stores the relationship between a luminous efficiency, calculated based on display luminance and backlight power, and display chromaticity. Herein, it stores a luminous efficiency at a steady state in connection with a chromaticity correction value or chromaticity corresponding to the luminous efficiency. The chromaticity represents chromaticity corresponding to a luminous efficiency at a steady mode, while the chromaticity correction value represents a chromaticity correction value corresponding to a difference between luminous efficiencies, the ratio between them, or a variation between them. For the sake of simplicity, it is possible to detect quantity of backlight, thus using it as the luminance of the display panel 10.

The chromaticity correction device 15 calculates a luminous efficiency based on the detection result of the backlight power detector 12 and the detection result of the display luminance detector 13, determines a chromaticity correction value corresponding to the calculated luminous efficiency, and corrects the display chromaticity of a video signal, thus matching the display chromaticity displayed on the display panel with target chromaticity. The chromaticity correction value is calculated using the current luminous efficiency and the information read from the luminous efficiency chromaticity storage unit 14 (i.e. a luminous efficiency or chromaticity at a steady state, a chromaticity correction value, etc.). The target chromaticity is a user's setting value, a standard value, or chromaticity at a steady state. For example, the luminous efficiency is calculated based on a ratio between the detection result of the backlight power detector 12 and the detection result of the display luminance detector 13.

The chromaticity correction device 15 compares the current luminous efficiency with the luminous efficiency at a steady state, stored in the luminous efficiency chromaticity storage unit 14, so as to detect a transient-state degree based on the comparison result, thus performing chromaticity correction on video based on the transient-state degree.

As the comparison, it is possible to use any one of a difference between the current luminous efficiency and the luminous efficiency at a steady state, the ratio between the current luminous efficiency and the luminous efficiency at a steady state, and a variation between the current luminous efficiency and the luminous efficiency at a steady state. The chromaticity correction device 15 correspondingly corrects a value of an LUT (Look-Up Table), installed therein or externally, based on the comparison result, thus correcting chromaticity.

FIG. 2 is a flowchart illustrating the operation of the display device having the configuration of FIG. 1.

In a power-on mode, the display device turns on the backlight 11 so as to display video on the display panel 10 in response to a video signal input thereto. The luminance detector 13 measures the display luminance of the display panel 10 (step S10). The backlight power detector 12 detects a backlight control value (step S11), thus calculating power consumption (step S12).

The chromaticity correction device 5 calculates a luminous efficiency based on the detection result of the backlight power detector 12 and the detection result of the display luminance detector 13 (step S13), reads the display chromaticity, corresponding to the calculated luminous efficiency, from the luminous efficiency chromaticity storage unit 14 (step S14), carries out characteristic collation by comparing the display chromaticity displayed on the display panel with read display chromaticity (step S15), and carries out correction for rewriting the date of LUT to achieve matching therebetween (step S16), thus correcting the display chromaticity of a video signal.

Another embodiment will be described below. It is possible to change a part of the processing of FIG. 2 below. That is, the chromaticity correction device 15 calculates a luminous efficiency based on the detection result of the backlight power detector 12 and the detection result of the luminance detector 13 (step S13), collates it with the luminous efficiency at a steady state (step S15), reads a chromaticity correction value, corresponding to a difference, a ratio, or a variation between two luminous efficiencies, from the luminous efficiency chromaticity storage unit 14 (step S14), and carries out correction for rewriting the data of LUT so as to match the display chromaticity with the target chromaticity (step S16), thus correcting the display chromaticity of a video signal.

The foregoing embodiment is designed to calculate power consumption, based on the predetermined characteristic, by use of a duty of a waveform for controlling flashing of a light source, to calculate a luminous efficiency based on the power consumption and the luminance, and to correct chromaticity by use of the luminous efficiency; hence, it is possible to carry out correction using a certain characteristic, which is closer to a real-state than a characteristic used in the steady-state correction, in a certain time period after a power-on mode. Additionally, the above correction is superior to the steady-state correction in terms of accuracy, responsibility, noise resistance, and cost (due to no need of a special sensor).

The existing technology needs to warm up a display device for thirty to sixty minutes before image evaluation and correction in order to prevent a transient temperature drift of a display device, whilst the foregoing embodiment is able to reduce a warming time.

The display device of the present embodiment, combined with the steady-state correction using temperature detection, is able to stabilize correction for both the transient state and the steady state. For example, it is possible to perform chromaticity correction according to the present embodiment in a certain time period after a power-on mode; thereafter, it is possible to perform steady-state correction.

FIG. 3 is a graph showing the relationship between a power-on elapsed time and a luminous efficiency or an internal temperature of a device. The horizontal axis represents a power-on elapsed time while the vertical axis represents a luminous efficiency and an internal temperature of a device. As shown in this graph, a luminous efficiency exhibits a large variation and rapidly changes in comparison with an internal temperature in a time period, in which an internal temperature does not increase sufficiently, after a power-on mode. For this reason, it is possible to reduce a warming time in the chromaticity correction using a luminous efficiency compared to the chromaticity correction using an internal temperature.

### INDUSTRIAL APPLICABILITY

The foregoing display device is applicable to industries, which need display devices demonstrating stable color reproduction, for example, in fields of graphic design, printing offices, and medical displays.

### REFERENCE SIGNS LIST

10 display panel
11 backlight
12 backlight power detector
13 luminance detector
14 luminous efficiency chromaticity storage unit
15 chromaticity correction device

1. A display device comprising:
a display panel for displaying an input video signal;
a backlight for illuminating the display panel;
a backlight power detector for detecting electrical power driving the backlight;
a luminance detector for detecting luminance of the display panel;
a luminous efficiency chromaticity storage unit for storing relationship between display chromaticity and a luminous efficiency calculated based on display luminance and backlight power; and
a chromaticity correction device for calculating the luminous efficiency based on a detection result of the backlight power detector and a detection result of the luminance detector, for reading the display chromaticity, corresponding to the calculated luminous efficiency, from the luminous efficiency chromaticity storage unit, and for correcting the display chromaticity of the video signal, thus matching the display chromaticity displayed on the display panel with the read display chromaticity.

2. A color correction method for a display device comprising:
detecting electrical power driving a backlight illuminating a display panel;
calculating a luminous efficiency based on backlight power and the luminance of the display panel;
reading display chromaticity corresponding to the calculated luminous efficiency from a luminous efficiency chromaticity storage unit for storing a relationship between the display chromaticity and the luminous efficiency calculated based on the display luminance and the backlight power; and
correcting the display chromaticity of a video signal input to the display panel, thus matching the display chromaticity displayed on the display panel with the read display chromaticity.

3. A color correction method adapted to a display device including a display panel, a backlight, and a storage unit storing a predetermined relationship between a luminous efficiency and a display chromaticity, comprising:
detecting luminance of the display panel;
detecting backlight power for driving the backlight illuminating the display panel;
calculating a current luminous efficiency based on the luminance of the display panel and the backlight power;
comparing the current luminous efficiency with a stable-mode luminous efficiency with reference to the storage unit, thus determining a color correction value based on a comparison result; and
correcting a video signal, input to the display panel, in response to the color correction value such that display chromaticity of the display panel matches target display chromaticity.
